(19) United States
(12) Patent Application Publication
(10) Pub. No.: US 2021/0223457 A1
(43) Pub. Date: Jul. 22, 2021

(54) BACKLIGHT MODULE AND LIQUID CRYSTAL DISPLAY DEVICE

(71) Applicant: WUHAN CHINA STAR OPTOELECTRONICS TECHNOLOGY CO., LTD., Wuhan (CN)

(72) Inventor: Shiyuan Xiao, Wuhan (CN)

(21) Appl. No.: 16/307,569

(22) PCT Filed: Aug. 10, 2018
(86) PCT No.: PCT/CN2018/099787

§ 371 Date: Dec. 6, 2018

(30) Foreign Application Priority Data
Jul. 25, 2018 (CN) 201810823472.5

(51) Int. Cl. F21V 8/00

(52) U.S. Cl. CPC G02B 6/0035

(57) ABSTRACT

A backlight module is provided and includes a light source and a light guide plate, wherein a scattering structure is disposed on a light-exiting side of the light guide plate, the scattering structure is configured to scatter light and the scattering structure is an asymmetric structure.

### FIELD OF INVENTION

The present disclosure relates to the field of display technology, and more particular to a backlight module and a liquid crystal display device.

### BACKGROUND OF INVENTION

As the development of liquid crystal display technology, the special requirements for liquid crystal display devices in various environments are also increasing. Because the working environment in the vehicle is complicated, the requirements for the vehicle-mounted display device are increased. In order to facilitate a driver to clearly observe an image or a number on a liquid crystal display device, the existing vehicle-mounted liquid crystal display device is generally a high-brightness liquid crystal display device.

However, in a conventional liquid crystal display device, a light bar which is composed of a high-efficiency light-emitting diode (LED) is generally served as a light source and the LED light source is converted into a uniform planar light source via a light guide sheet, so that when the liquid crystal display device is in a working state, brightness of the entire display area is relatively uniform and bright. Usually, only a part of the display area shows the images and numbers that the driver needs to observe. At this time, it is difficult for the driver to notice the road traffic through the mirror due to the strong light which is illuminated on a vehicle interior mirror from the other parts of the display area. This may lead to an accident.

### SUMMARY OF INVENTION

The present disclosure provides a backlight module to solve the problem that the strong light in a non-observation region is illuminated on the interior mirror when a liquid crystal display device is in a working state which leads to an accident.

In order to solve the above problems, the technical solution provided by the present disclosure is as follows:

A backlight module, including

a light source; and

a light guide plate;

wherein a scattering structure is disposed on a light-exiting side of the light guide plate, the scattering structure is configured to scatter light, and the scattering structure is an asymmetric structure; and wherein a light-incident surface is disposed on a side surface of the light guide plate adjacent to the light-exiting side, and a light-emitting surface of the light source is parallel to and faces the light-incident surface.

Preferably, a light-exiting surface is disposed on the light-exiting side of the light guide plate and the asymmetric structure is disposed on the light-exiting surface of the light guide plate.

Preferably, a transparent film is disposed on the light-exiting side of the light guide plate and the asymmetric structure is disposed on a side of the transparent film which is away from the light guide plate.

Preferably, the scattering structure is a continuous structure.

Preferably, the scattering structure is wavy.

Preferably, the scattering structure is a discontinuous structure.

Preferably, the scattering structure includes mutually independent peaks.

Preferably, a shape of the peak is a pyramid shape or a cone shape.

The present disclosure also provides a liquid crystal display device, including a liquid crystal panel and a backlight module as described above.

A backlight module, including

a light source; and

a light guide plate;

wherein a scattering structure is disposed on a light-exiting side of the light guide plate, the scattering structure is configured to scatter light, and the scattering structure is an asymmetric structure.

Preferably, a light-exiting surface is disposed on the light-exiting side of the light guide plate and the scattering structure is disposed on the light-exiting surface of the light guide plate.

Preferably, a transparent film is disposed on the light-exiting side of the light guide plate and the scattering structure is disposed on a side of the transparent film which is away from the light guide plate.

Preferably, the scattering structure is a continuous structure.

Preferably, the scattering structure is wavy.

Preferably, the scattering structure is a discontinuous structure.

Preferably, the scattering structure includes mutually independent peaks.

Preferably, a shape of the peak is a pyramid shape or a cone shape.

The present disclosure possesses the beneficial effects that an asymmetric viewing brightness is formed within a space by an asymmetric scattering structure, and thus reducing brightness of the light on the non-observation area in the display area, so that the strong light which is emitted by the non-observation area is prevented from being illuminated on a vehicle interior mirror and results in an accident. The strong light which is emitted by the non-observation area is concentrated on the observation area for enhancing the brightness of the observation area, so that the observation area achieves high brightness with fewer light sources or light sources having lower luminous intensity and production cost is reduced.

### DESCRIPTION OF DRAWINGS

In order to illustrate a technical solution in the embodiments or in the prior art more clearly, the accompanying drawings required in the description of the embodiments or the prior art are introduced briefly hereafter. It is obvious that the accompanying drawings in the following description are merely part of the embodiments of the present invention. People with ordinary skills in the art can obtain other drawings without making inventive efforts.

FIG. 1 is a structural schematic view of a backlight module according to a preferred implement of the present disclosure.

FIG. 2 is a structural schematic view of a backlight module according to another preferred implement of the present disclosure.

FIG. 3 is a structural schematic diagram of a backlight module according to the second embodiment of the present disclosure.

Reference numerals: 10, light source; 20, light guide plate; 21, light-exiting surface; 22, light-incident surface; 30, scattering structure; and 40, transparent film.

### DETAILED DESCRIPTION OF THE PREFERRED EMBODIMENTS

In the following detailed description, reference is made to the accompanying figures, in which various examples are shown by way of illustration. In this regard, directional terminology mentioned in the present disclosure, such as “top”, “bottom”, “front”, “back”, “left”, “right”, “inner”, “outer”, “lateral”, etc., is used with reference to the orientation of the figures being described. Therefore, the directional terminology is used for purposes of illustration and is not intended to limit the present invention. In the accompanying figures, units with similar structures are indicated by the same reference numbers.

With respect to the existing backlight module. When a liquid crystal display device is in a working state, the brightness of the entire display surface is uniformly bright. Usually, a part of the display area shows the images and numbers that the driver needs to observe. At this time, it is difficult for the driver to notice the road traffic through the mirror due to the strong light which is illuminated on a vehicle interior mirror from the other parts of the display area. This may lead to an accident. This embodiment can solve the above problems.

### The First Embodiment

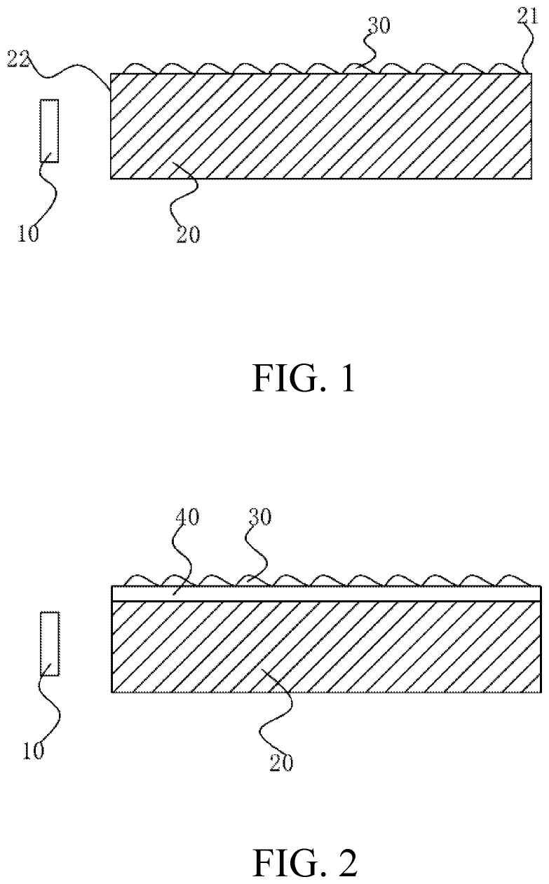

As shown in FIG. 1, a backlight module includes a light source 10 and a light guide plate 20; wherein a scattering structure 30 is disposed on a light-exiting side of the light guide plate 20, the scattering structure 30 is configured to scatter light, and the scattering structure is an asymmetric structure, i.e. outer geometry and/or material composition of the scattering structure 30 is configured to be asymmetric.

When a vehicle-mounted liquid crystal display device is in operation, in the display area of the liquid crystal display device, the area where shows an image and a number which the driver needs to observe is defined as an observation area, and the area without the image and the number is defined as non-observation area. By converting the light of the light source 10 into a planar light source 10 via light guide plate 20 and scattering structure 30, and using the asymmetric morphology of the scattering structure 30 at the same time, an asymmetric viewing brightness is form within a space. The brightness of the light on the non-observation area in the display area is reduced, so that the strong light which is emitted by the non-observation area is prevented from being illuminated on a vehicle interior mirror and results in an accident. The strong light which is emitted by the non-observation area is concentrated on the observation area for enhancing the brightness of the observation area, so that the observation area achieves high brightness with fewer light sources 10 or light sources 10 having lower luminous intensity and production cost is reduced.

In a preferred embodiment of the present disclosure, a light-exiting surface 21 is disposed on the light-exiting side of the light guide plate 20. The scattering structure 30 is disposed on the light-exiting surface 21 of the light guide plate 20. The asymmetric scattering structure 30 is disposed on the light-exiting surface of the light guide plate to reduce a thickness of the light guide plate 20 and reduce a loss of light when passing through the light guide plate 20.

It is noted that the scattering structure 30 can be integrally formed with the light guide plate 20. The scattering structure 30 can also be processed on the light guide plate 20 after the light guide plate 20 is formed.

As shown in FIG. 2, in another preferred embodiment of the present disclosure, a transparent film 40 is disposed on the light-exiting side of the light guide plate 20 and the scattering structure 30 is disposed on a side of the transparent film 40 which is away from the light guide plate 20. After the light guide plate 20 and the transparent film 40 having the scattering structure 30 are separately produced, the transparent film 40 is combined with the light guide plate 20 to avoid damage to the light guide plate 20 when the scattering structure 30 is directly formed on the light guide plate 20.

It is noted that a size of the transparent film 40 is adapted to a size of the light-exiting side of the light guide plate 20. In an actual production process, the transparent film 40 having the scattering structure 30 can be produced in the form of a roll, and an upper glue layer is uniformly coated on the bottom surface of a film by a film coating process and a floor protective film is pasted on the upper glue layer. Then, the transparent film 40 is cut into a shape corresponding to the size of the light-exiting side of the light guide plate 20 by a die-cutting process. Next, the strip-shaped film is adhered to the light-exiting side of the light guide plate 20.

The scattering structure 30 is a continuous structure, and the scattering structure 30 is wavy. The continuous asymmetric structure increases the scattering of light and better achieve the purpose of asymmetric viewing brightness.

A light-incident surface 22 is disposed on a side surface of the light guide plate 20 adjacent to the light-exiting side, and a light-emitting surface of the light source 10 is parallel to and faces the light-incident surface 22. The light-receiving mode of the backlight module employs a side-edge type of backlight module. After the light emitted by the light source 10 is illuminated on the light guide plate 20 by passing through the light-incident surface 22, when the light is emitted from the light-exiting side of the light guide plate 20, a planar light source 10 is formed by scattering the light with the scattering structure 30. The light source 10 is positioned at a side plate of the light guide plate 20, which can reduce the overall thickness of the backlight module. The light-emitting surface of the light source 10 is parallel to and faces the light-incident surface 22 of the light guide plate 20 and thus increasing the illumination efficiency of the light guide plate 20.

It is noted that the light-incident surface 22 may be disposed on each of the sides of the light guide plate 20 and the light source may be disposed on each side of the light guide plate corresponding to each light-incident surface 22.

It is noted that, in this embodiment, the light source 10 is a light emitting diode. It is appreciated that the light source 10 can also be a cold cathode fluorescent lamp.

Specifically, the light source 10 can be composed of one or more light emitting diodes.

A liquid crystal display device includes a liquid crystal panel and a backlight module as described above.

### The Second Embodiment

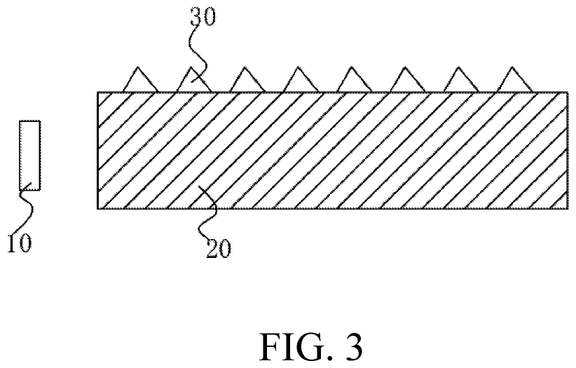

As shown in FIG. 3 is a backlight module which differs from the first embodiment only in that the scattering structure 30 is a discontinuous structure.

The scattering structure 30 includes mutually independent peaks and a shape of the peak is a pyramid shape or a cone shape. The light is scattered by the mutually independent peak structures, thereby facilitating the formation of a more distinct asymmetric viewing brightness within the space, effectively reducing the brightness of the light in the non-observation area, and enhancing the brightness of the light in the observation area.

It is appreciated that in a specific implementation, the peaks may also be other shapes, such as a circular arc, an elliptical arc, or a polygon.

The beneficial effects of the present disclosure are: forming an asymmetric viewing angle brightness within the space by the asymmetric scattering structure 30, and thus reducing brightness of a light on a non-observation area in the display area, so that the strong light which is emitted by the non-observation area is prevented from being illuminated on a vehicle interior mirror and results in an accident. The strong light which is emitted by the non-observation area is concentrated on an observation area for enhancing the brightness of the observation area, so that the observation area achieves high brightness with fewer light sources or light sources having lower luminous intensity and production cost is reduced.

1. A backlight module, comprising:
a light source; and
a light guide plate;
wherein a scattering structure is disposed on a light-exiting side of the light guide plate, the scattering structure is configured to scatter light, and the scattering structure is an asymmetric structure; and wherein a light-receiving surface is disposed on a side surface of the light guide plate adjacent to the light-exiting side, and a light-emitting surface of the light source is parallel to and faces the light-receiving surface.

2. The backlight module according to claim 1, wherein a light-exiting surface is disposed on the light-exiting side of the light guide plate and the asymmetric structure is disposed on the light-exiting surface of the light guide plate.

3. The backlight module according to claim 1, wherein a transparent film is disposed on the light-exiting side of the light guide plate and the asymmetric structure is disposed on a side of the transparent film which is away from the light guide plate.

4. The backlight module according to claim 1, wherein the scattering structure is a continuous structure.

5. The backlight module according to claim 4, wherein the scattering structure is wavy.

6. The backlight module according to claim 1, wherein the scattering structure is a discontinuous structure.

7. The backlight module according to claim 6, wherein the scattering structure comprises mutually independent peaks.

8. The backlight module according to claim 7, wherein a shape of the peak is a pyramid shape or a cone shape.

9. A liquid crystal display device comprising a liquid crystal panel, and the backlight module according to any one of claims 1 to 8.

10. A backlight module, wherein the backlight module comprises:
a light source; and
a light guide plate;
wherein a scattering structure is disposed on a light-exiting side of the light guide plate, the scattering structure is configured to scatter light, and the scattering structure is an asymmetric structure.

11. The backlight module according to claim 10, wherein a light-exiting surface is disposed on the light-exiting side of the light guide plate and the asymmetric structure is disposed on the light-exiting surface of the light guide plate.

12. The backlight module according to claim 10, wherein a transparent film is disposed on the light-exiting side of the light guide plate and the asymmetric structure is disposed on a side of the transparent film which is away from the light guide plate.

13. The backlight module according to claim 10, wherein the scattering structure is a continuous structure.

14. The backlight module according to claim 13, wherein the scattering structure is wavy.

15. The backlight module according to claim 10, wherein the scattering structure is a discontinuous structure.

16. The backlight module according to claim 15, wherein the scattering structure comprises mutually independent peaks.

17. The backlight module according to claim 16, wherein a shape of the peak is a pyramid shape or a cone shape.
